(19) United States
(12) Patent Application Publication
(10) Pub. No.: US 2026/0323491 A1
(43) Pub. Date: Oct. 15, 2026

(54) COMMUNICATION DEVICE, CONTROL METHOD, AND STORAGE MEDIUM

(71) Applicant: CANON KABUSHIKI KAISHA, Tokyo (JP)

(72) Inventor: DAISUKE HORIO, Kanagawa (JP)

(21) Appl. No.: 19/465,515

(22) Filed: Jan. 30, 2026

Related U.S. Application Data
(63) Continuation of application No. PCT/JP2024/025875, filed on Jul. 19, 2024.

(30) Foreign Application Priority Data
Aug. 2, 2023 (JP) 2023-126062

(51) Int. Cl. H04W 48/16; H04W 68/00; H04W 72/0453; H04W 76/10

(52) U.S. Cl. CPC H04W 48/16; H04W 68/005; H04W 72/0453; H04W 76/10

(57) ABSTRACT

Disclosed is a communication device including a reception unit configured to receive notification signals of a plurality of band types from a base station, and a connection control unit configured to, in a case where the communication device functions as a mobile IAB node, preferentially attempt connection to one or more base stations that transmit, among the notification signals, a notification signal of a second band type among a first band type related to millimeter waves and the second band type related to a wavelength longer than millimeter waves.

### CROSS-REFERENCE TO RELATED APPLICATIONS

This application is a Continuation of International Patent Application No. PCT/JP2024/025875, filed Jul. 19, 2024, which claims the benefit of Japanese Patent Application No. 2023-126062, filed August 2, 2023, both of which are hereby incorporated by reference herein in their entirety.

### BACKGROUND

### Field of the Technology

The present disclosure relates to a communication device, a control method, and a storage medium.

### Description of the Related Art

In the 3rd Generation Partnership Project (3GPP®), standardization of Integrated Access and Backhaul (IAB) as a communication technology for backhaul is underway. In IAB, the radio resources used for the access line between a base station and a user equipment (UE) are also used for the backhaul line. By using IAB for the backhaul line, a relay station (IAB node) can relay communication between a base station (IAB donor) and a UE via a wireless line, thereby improving the connectivity of the radio access network. For example, in IAB, radio resources in the millimeter wave band, such as the 28 GHz band, are mainly used (Japanese Patent Laid-Open No. 2019-534625). The IAB node searches for notification signals from the IAB donor or another IAB node to determine a connection destination and form an IAB network.

To further improve the connectivity of wireless access networks, mobile IAB nodes to be installed in vehicles such as buses, taxis, and trains are being considered. By using mobile IAB nodes, it is expected not only to provide good communication services inside the vehicle but also to improve communication quality in areas with locally poor radio wave conditions or congested areas.

However, when a mobile IAB node uses radio waves in the millimeter wave band as the band type for the backhaul line, communication may become unstable and prone to interruptions due to the strong straight-line propagation characteristics.

### SUMMARY

The present disclosure has been made in consideration of at least one of the above-described issues. The present disclosure is directed to providing a mechanism that enables an IAB node to connect to an appropriate IAB donor by narrowing down the band types used by an IAB node for the backhaul line and searching accordingly.

According to an aspect of the present disclosure, a communication device includes a reception unit configured to receive notification signals of a plurality of band types from a base station, and a connection control unit configured to, in a case where the communication device functions as a mobile IAB node, preferentially attempt connection to one or more base stations that transmit, among the notification signals, a notification signal of a second band type among a first band type related to millimeter waves and the second band type related to a wavelength longer than millimeter waves.

Features of the present disclosure will become apparent from the following description of embodiments with reference to the attached drawings.

### BRIEF DESCRIPTION OF THE DRAWINGS

FIG. 1 is a diagram illustrating a configuration example of a wireless communication system.

FIG. 2 is a hardware functional block diagram of a communication device operable as a mobile IAB node.

FIG. 3 is a software functional block diagram of the communication device operable as a mobile IAB node.

FIG. 4 is a sequence diagram illustrating an example of a cell search process performed by the communication device operable as a mobile IAB node.

FIG. 5 is a flowchart illustrating an example of a cell search process performed by the communication device operable as a mobile IAB node (first embodiment).

FIG. 6 is a flowchart illustrating an example of a cell search process performed by a communication device operable as a mobile IAB node (second embodiment).

### DESCRIPTION OF THE EMBODIMENTS

Embodiments will be described in detail below with reference to the accompanying drawings. In the following description, the "number ***" in TS*** represents the number of the technical specification in the 3rd Generation Partnership Project (3GPP) standard.

The embodiments described below relate to techniques for performing appropriate communication control to form a stable Integrated Access and Backhaul network (IAB) network when a mobile communication device having a relay function (mobile IAB node) performs cell search operations. The mobile IAB node is also referred to as a mobile base station relay (MBSR).

### First Embodiment

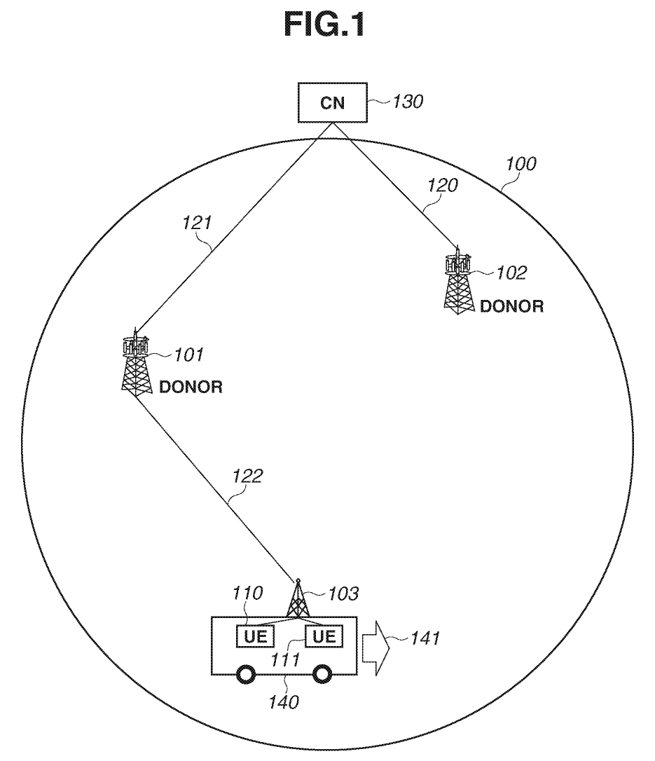

FIG. 1 illustrates an example of a wireless communication system (IAB network 100) according to an embodiment of the present disclosure.

In the IAB network 100, there are donors 101 and 102 that provide connectivity to a core network (CN) 130. The donors are also referred to as IAB donors. A communication device 103 can operate as an IAB node under predetermined conditions. The communication device 103 is approaching an authorized area where the communication device 103 can operate as an IAB node. Having entered the authorized area, the communication device 103 returns from a sleep state and initiates a search operation to form an IAB network with either the donor 101 or the donor 102.

In New Radio (NR), frequency ranges referred to as Frequency Range(FR) 1, which covers 410 MHz to 7125 MHz, FR2-1, which covers 24.25 GHz to 52.6 GHz, and FR2-2, which covers 52.6 GHz to 71 GHz, are defined. FR2-1 is also referred to as FR2. Within FR1, FR2-1, and FR2-2, a plurality of frequency bands is defined. For example, operating bands n1 to n105 for NR are defined in FR1, and operating bands n257 to n263 are defined in FR2. FR1 includes frequency bands used for Long Term Evolution (LTE) and frequency bands referred to as Sub-6 GHz (Sub6). FR2 is also referred to as millimeter wave (mmWave).

In the present embodiment, the bands defined in FR1 and FR2 (FR2-2 may be included) may be used as the bands employed in IAB. Additionally, frequency bands used in LTE, specifically those from 700 MHz to 3.5 GHz, and frequency bands referred to as Sub6, specifically those from 3.6 GHz to 4.6 GHz, may also be used. In the mmWave band, frequencies from 27 GHz to 29.5 GHz may be used. In the following description, it is assumed that IAB utilizes three types of bands: frequency bands used in LTE (hereinafter referred to as “LTE”), frequency bands referred to as Sub6 (hereinafter referred to as “Sub6”), and mmWave bands. However, the present embodiment is not limited to this configuration. For example, IAB may utilize two types of bands: bands included in FR1 and bands included in FR2. Alternatively, IAB may utilize two types of bands: bands with frequencies lower than the mmWave band (i.e., bands with longer wavelengths than the mmWave band) and bands in the mmWave band. Furthermore, the above-mentioned “frequency bands used in LTE” may be interpreted as “frequency bands lower than Sub6.”

Herein, Core Network (CN) is responsible for various processes, such as authentication of user equipment (UE) 110 and 111, which serves as terminals, and registration for slice usage.

The communication device 103 has not yet started operating as an IAB node, so that the UE 110 and UE 111 are connected to the donor 101 and are currently performing data communication with the CN 130.

The UE 110 and UE 111 are mobile terminals used by passengers of a bus 140.

Referring to FIG. 1, the communication device 103 is mounted on the bus 140. In this case, the communication device 103 can function as a mobile IAB node that moves together with the movement of the bus 140. When the bus 140 moves in a traveling direction 141, the communication device 103 mounted on the bus 140 can receive broadcast information from either the donor 101 or the donor 102. The donors 101 and 102 transmit notification signals for each band type, including LTE, Sub6, and millimeter waves. The donors 101 and 102 transmit a Master Information Block (MIB) and a System Information Block (SIB) as notification signals for each band type. In the present embodiment, in a case where the communication device 103 returns from a sleep state and functions as a mobile IAB node, the communication device 103 attempts to preferentially connect to one or more donors that transmit notification signals of a specific band type (an example of a second band type). The specific band type includes one or more band types corresponding to wavelengths longer than those of millimeter waves.

Herein, " preferential connection attempt" includes attempting connection to one or more connection candidate donors that transmit notification signals of the specific band type, by selecting only the specific band type as the target for searching. Alternatively, "preferential connection attempt" includes attempting connection to one or more connection candidate donors that transmit notification signals of the specific band type, by selecting the specific band type as well as other band types as search targets.

In a case where there is a plurality of connection candidate donors that transmit notification signals of the specific band type, a donor to which connection is to be preferentially attempted may be determined from among the plurality of connection candidate donors, based on the values of other parameters. In this case, the other parameters may be related to communication quality, such as radio signal strength, in which case preferential connection may be attempted to the donor associated with the parameter value indicating good communication quality. Alternatively, the other parameters may be the bandwidth of the specific band type. For example, if there are two or more specific band types and one of the specific band types has a wider bandwidth than the others, preferential connection may be attempted to the donor that transmits notification signals of that specific band type. Furthermore, if notification signals from one donor for which preferential connection is to be attempted can be received in a plurality of specific band types, preferential connection may be attempted using the band type with the wider bandwidth.

Referring to FIG. 1, the communication device 103 having returned from the sleep state selects Sub6 and LTE, excluding the millimeter waves, as candidate band types for connecting to a base station, to operate as a mobile IAB node.

The communication device 103 starts a search operation using the Sub6 and LTE band types and selects the donor 101 as the connection destination. Between Sub6 and LTE, the communication device 103 performs connection processing using Sub6, which can secure the widest bandwidth, as the band type for connecting to the donor 101. The communication device 103 performs Radio Resource Control (RRC) connection processing in accordance with the information in the MIB and SIB transmitted at Sub6 frequencies. In response to completing the RRC connection processing with the donor 101, the communication device 103 forms an IAB network as a mobile IAB node. The communication device 103 starts operating as an IAB node and transmits notification signals. The UE 110 and UE 111 receive the notification signal from the communication device 103, which has stronger radio wave strength than the donor 101, and change their connection to the communication device 103, which provides a better radio wave environment. The UE 110 and UE 111 continue data communication with the CN 130 via the communication device 103 through the donor 101 in a stable environment.

In the present embodiment, the communication device 103 is assumed to be mounted on the bus 140, but may also be an IAB node mounted on a movable object, such as another vehicle, aircraft, or ship, or on a person.

In the above description related to FIG. 1, like the donor 101, the donor 102 also transmits notification signals of the Sub6 and LTE bands. Thus, in this case, the communication device 103 may select the donor 102 as the connection destination instead of the donor 101. At this time, communication quality information, such as radio wave strength, and communication control information, such as available band types, in relation to the donors 101 and 102 obtained in this situation may be compared and considered. For example, if the donor 102 has better radio wave strength than the donor 101, the communication device 103 may select the donor 102 as the connection destination instead of the donor 101.

Unlike the above description related to FIG. 1, if the donor 101 does not transmit notification signals of the Sub6 and LTE band types, but transmits only notification signals of the millimeter wave band type, the following may apply. In this case, the communication device 103 may select the donor 102 as the connection destination instead of the donor 101.

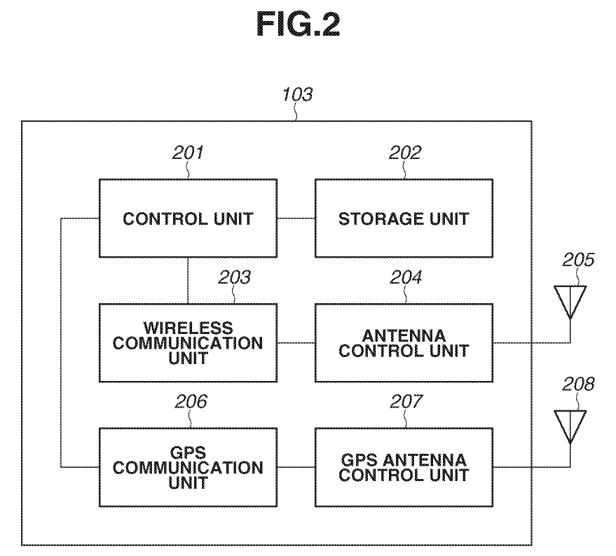

FIG. 2 is a block diagram illustrating a hardware configuration example of the communication device 103.

The hardware configuration of the communication device 103 includes a control unit 201, a storage unit 202, a wireless communication unit 203, an antenna control unit 204, an antenna, a global positioning system (GPS) communication unit 206, a GPS antenna control unit 207, and a GPS antenna 208.

The control unit 201 includes one or more processors, such as central processing unit(s) (CPUs) or micro processing unit(s) (MPUs). The control unit 201 may also include a field programmable gate array (FPGA), a digital signal processor (DSP), an application specific integrated circuit (ASIC), or the like. The control unit 201 controls the entire device by executing control programs stored in the storage unit 202, for example. In other words, the processor of the control unit 201 and the storage unit 202 function as a computer that controls the communication device 103.

The storage unit 202 includes one or more storage devices (memories), such as a random access memory (RAM), a read only memory (ROM), a hard disk drive (HDD), and a solid state drive (SSD). The storage unit 202 is configured to store various programs (e.g., control programs) executed by the control unit 201, and various types of information used in processing performed by the control unit 201. The various types of information may be communication quality information, such as radio wave strengths related to the donors 101 and 102, communication control information, such as available band types, and the like, for example.

The communication quality information includes information related to communication quality. For example, the communication quality information may include a received signal strength indicator (RSSI), a reference signal received quality (RSRQ), a reference signal received power (RSRP), and the like. In addition, the communication quality information may include a modulation and coding scheme (MCS), a signal to noise ratio (SNR), a communication speed, and the like.

The communication control information includes information to be used for performing connection processing with the donors 101 and 102, such as band types and frequency channels that can be acquired from the notification signals of the donors 101 and 102. The communication control information and communication quality information are acquired by measuring the MIB and SIB included in the notification signals, or by measuring the Synchronization Signal Block (SSB) described below.

The wireless communication unit 203 performs processing related to wireless communication (cellular communication) that complies with 3GPP standards, such as the LTE standard or the fifth generation (5G) standard. However, the wireless communication unit 203 is also applicable to standards other than 5G (e.g., 5G Advanced, sixth generation (6G)). The wireless communication unit 203 includes circuits for communication processing, such as a baseband chip and a radio frequency (RF) chip.

The antenna control unit 204 controls an antenna 205 used for wireless communication performed by the wireless communication unit 203. The antenna control unit 204 is capable of measuring communication quality based on signals received by the antenna 205. The antenna control unit 204 may generate RSSI indicating the received signal strength or may generate SNR, for example, as communication quality information indicating the measurement result of the search operation.

The communication quality may be measured using an SSB which is periodically transmitted (broadcast) from the donors 101 and 102, for example. The SSB is a synchronization signal/broadcast channel block (SS/PBCH block). The synchronization signal/broadcast channel block includes a synchronization signal (SS) and a physical broadcast channel (PHCH). The SSB is periodically transmitted from the base station mainly for UE to detect the cell ID and the reception timing at the start of communication. In NR, the SSB is also used to measure the reception quality of each cell. The PBCH includes an MIB.

The antenna control unit 204 controls an antenna 205 used for wireless communication performed by the wireless communication unit 203. The antenna control unit 204 is capable of measuring communication quality information.

The GPS communication unit 206 receives signals from GPS satellites to acquire current position information including location-specific information, such as longitude and latitude information, and current time information. Instead of the GPS, other satellite positioning systems within the global navigation satellite system (GNSS) may also be used.

The GPS antenna control unit 207 controls the antenna 208 for GPS communication performed by the GPS communication unit 206.

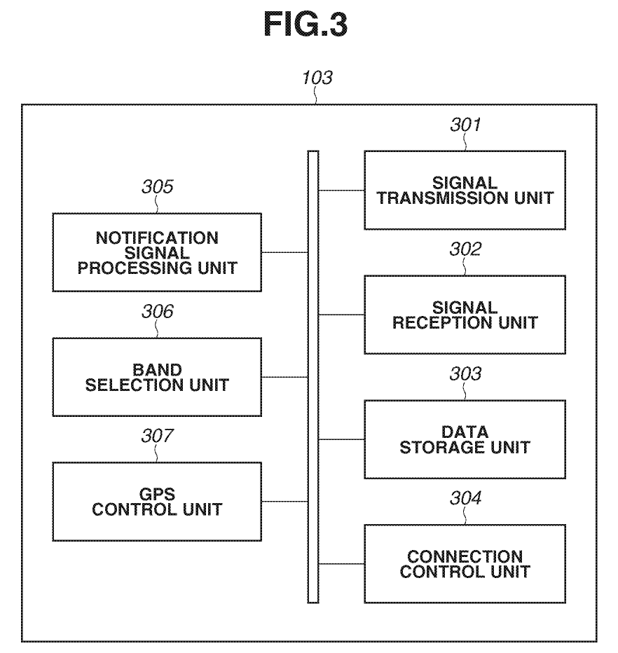

FIG. 3 is a block diagram illustrating a functional configuration example of software of the communication device 103.

The communication device 103 includes a signal transmission unit 301, a signal reception unit 302, a data storage unit 303, a connection control unit 304, a notification signal processing unit 305, a band selection unit 306, and a GPS control unit 307. The function of each block illustrated in FIG. 3 can be implemented by the control unit 201 executing control programs stored in the storage unit 202.

The signal transmission unit 301 and the signal reception unit 302 control the wireless communication unit 203 to transmit and receive wireless signals between an IAB donor or other IAB nodes (e.g., the donors 101 and 102) and UE (e.g., UE 110 to UE 112). The signal transmission unit 301 and the signal reception unit 302 transmit and receive wireless signals that comply with 3GPP standards, such as the LTE standard or the 5G standard.

The signal reception unit 302 receives notification signals from an IAB donor or other IAB nodes (e.g., donors 101 and 102). The signal reception unit 302 performs control to receive signals of all band types, including LTE, Sub6, and millimeter wave, until the band selection unit 306 selects the band type with which to connect.

The data storage unit 303 stores various programs and various types of data (various types of information) in the storage unit 202 to hold them.

The connection control unit 304 performs processing related to the connection to the IAB network, such as transmitting and receiving RRC messages between the communication device 103 and the donors 101 and 102. The connection control unit 304 also performs processing related to the connection with the UE 110 and 111 and the connection with the CN 130. The connection control unit 304 controls the cell search operation performed by the communication device 103 and determines an IAB donor or IAB node to connect to form an IAB network. In the present embodiment, the donor 101 is determined as the connection destination.

The connection control unit 304 controls the antenna control unit 204 during wireless communication. The connection control unit 304 acquires communication quality information from the antenna control unit 204 and transmits the acquired communication quality information to the data storage unit 303.

The notification signal processing unit 305 extracts communication control information, such as available band types and channel information, included in the notification signals received from the donors 101 and 102, transmits the information to the data storage unit 303, and stores the information in the storage unit 303. For example, the communication control information is used in establishing an RRC link by the connection control unit 304. The channel information includes communication control information, such as information indicating bandwidth and resource block (RB) allocation information.

The band selection unit 306 selects a band type that can secure the widest bandwidth between the band selection unit 306 and the destination IAB donor or IAB node, based on the communication control information and communication quality information. The communication device 103 transmits the selected band type to the connection control unit 304 to execute the RRC connection process using the selected band type.

The GPS control unit 307 performs communication in compliance with GPS standards. The GPS control unit 307 controls the antenna for GPS communication and calculates the current position and time from the received GPS information. The GPS control unit 307 outputs information in a format, such as National Marine Electronics Association (NMEA)-0183, and, if necessary, stores the current position and time in the data storage unit 303.

The communication device 103 determines whether the communication device 103 is located inside or outside the authorized area in which the communication device 103 can operate as an IAB node, based on the current position acquired by the GPS control unit 307.

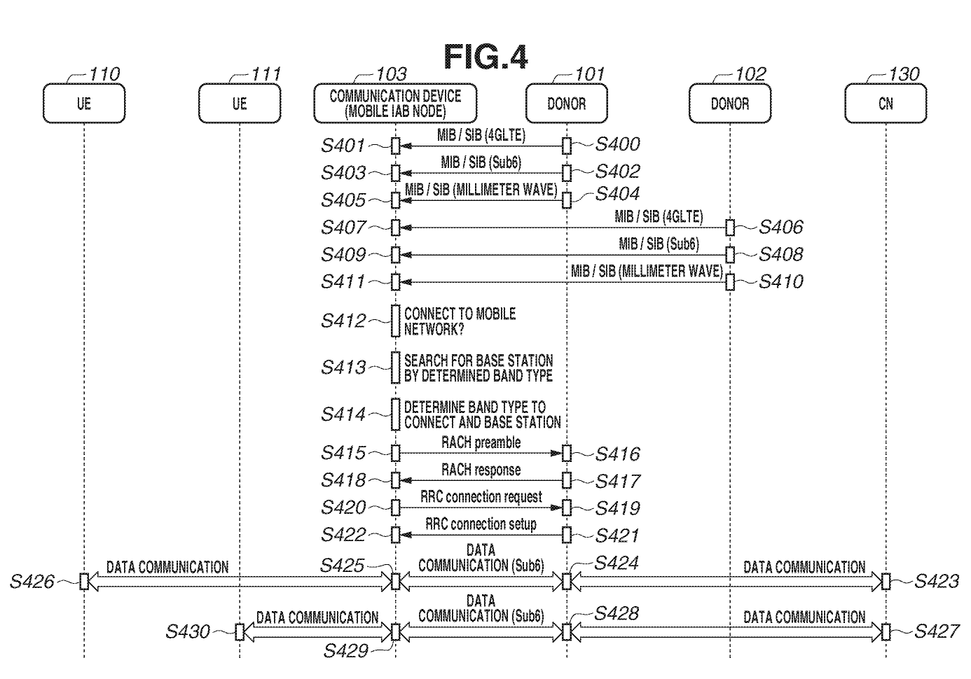

FIG. 4 is a sequence diagram illustrating an example of a cell search process of the communication device 103 according to the present embodiment.

In step S400, the donor 101 transmits a notification signal in the LTE band type (an example of the second band type). In this step, the reception of the notification signal by the communication device 103 may be omitted. The notification signal may be received, but decoding, analysis, and the like of the notification signal may be omitted. This also applies to the following steps S402, S404, and S406 to S411.

In step S402, the donor 101 transmits a notification signal in the Sub6 band type (an example of the second band type).

In step S404, the donor 101 transmits a notification signal in the millimeter wave band type (an example of the first band type).

Similarly, in steps S406 to S411, the donor 102 transmits a notification signal using the LTE, Sub6, and millimeter wave band types.

In step S412, the communication device 103 moves into the authorized area, so that the communication device 103 returns from the sleep mode and starts operation for connecting to the mobile network.

In step S413, the communication device 103 functions as a mobile IAB node, so that the communication device 103 determines the band types to be LTE and Sub6, which are band types excluding the millimeter wave band, and starts searching for base stations (e.g., the donors 101 and 102) using only the determined band types.

The communication device 103 may periodically operate the antenna control unit 204 to receive notification signals even during the sleep mode, or may start receiving notification signals from the start of the search operation in step S413 after returning from the sleep mode. The GPS antenna control unit 207 and the GPS communication unit 206 are assumed to operate even during the sleep mode so that the communication device 103 can determine whether the communication device 103 is located inside or outside the authorized area.

In step S414, the communication device 103 determines a base station (e.g., donor 101) to connect and a band type based on the results of search in step S413. The communication device 103 determines a single band type from among a plurality of band types selected in step S413, based on communication control information such as channel information and communication quality information, to be the band type that can secure the widest bandwidth. For example, based on the communication control information and communication quality information of the donor 101, between LTE and Sub6, Sub6 is determined to be the band type with better communication quality and a higher frequency bandwidth or corresponding MCS.

In step S415, the communication device 103 transmits to the donor 101 a preamble, which is a fixed pattern randomly selected for the band type determined in step S414, as a RACH preamble message.

In step S416, the donor 101 receives the RACH preamble message.

In step S417, the donor 101 transmits a RACH response message to the communication device 103 as information indicating that the RACH preamble message has been received, as well as transmission timing information and bandwidth allocation information.

In step S418, the communication device 103 receives the RACH response message.

In step S419, in accordance with the transmission timing and bandwidth allocation information contained in the RACH response message received in step S418, the communication device 103 transmits an RRC connection request to the donor 101. The RRC connection request is an RRC connection request message.

In step S420, the donor 101 receives the RRC connection request message.

In step S421, the donor 101 transmits control information for RRC connection as a RRC connection setup message in response to the RRC connection request.

In step S422, in response to having received the RRC connection setup message, the communication device 103 completes the RRC link connection. In this case, the communication device 103 starts transmission of a notification signal as an IAB node.

At this time, the UE 110 and UE 111 receive the notification signal from the communication device 103 and change the connection from the currently connected donor 101 to the communication device 103, which provides a better communication environment.

In steps S423 to S426, the UE 110, whose connection has been changed, performs data communication with the CN 130 via the communication device 103 through the donor 101.

Similarly, in steps S427 to S430, the UE 111 performs data communication with the CN 130 via the communication device 103 through the donor 101.

At this time, communication between the communication device 103 and donor 101 over the backhaul line is performed, for example, using the Sub6 band type.

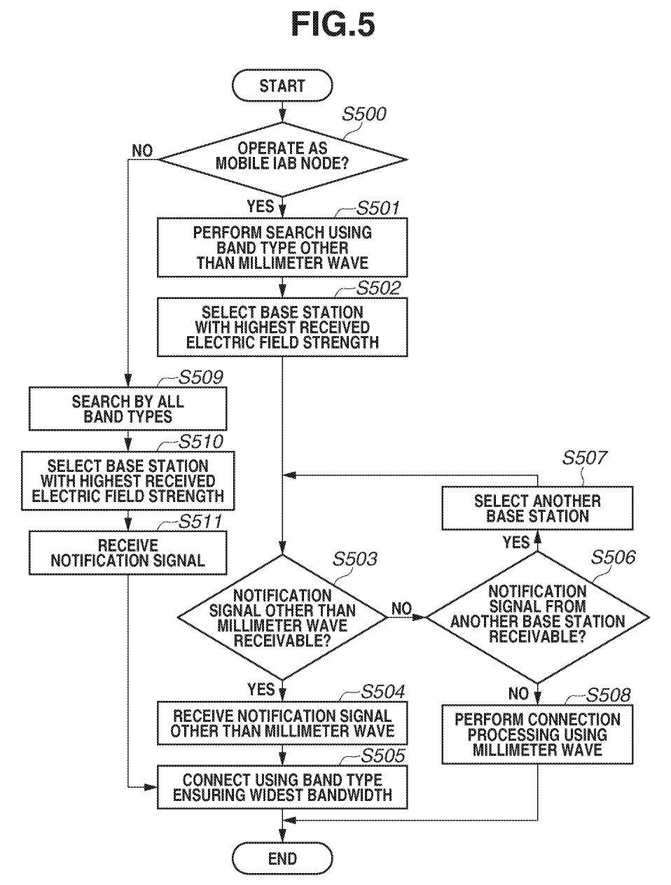

FIG. 5 is a flowchart illustrating an example of a cell search performed by the communication device 103 according to the present embodiment.

A processing flowchart for the cell search operation in steps S413 and S414 will be described.

In step S500, the communication device 103 determines whether the communication device 103 functions as a mobile IAB node. Examples of IAB node types other than the mobile IAB node include fixed IAB nodes. In the case of functioning as a mobile IAB node (YES in step S500), the communication device 103 executes the operation in step S501, and if not (NO in step S500), the communication device 103 executes the operation in step S509.

In step S501, since the communication device 103 operates as a mobile IAB node, the communication device 103 performs a search using a band type other than the millimeter wave. In this search, information for identifying base stations or cells transmitting notification signals and the received electric field strength of radio waves receivable by the antenna 205 are assumed to be obtained. On the other hand, in the search, the radio field strength for each band type is assumed to be unknown. In other words, communication quality information and communication control information for each band type are not clear until the SSB is measured and the MIB and SIB are analyzed to extract information.

In step S502, the communication device 103 selects the base station with the highest received electric field strength from the search results.

In step S503, the communication device 103 determines whether notification signals of band types other than the millimeter wave can be received from the base station selected in step S502. Whether notification signals of the band types other than the millimeter wave can be received is determined by analyzing the MIB or SIB information. If notification signals of the band types other than the millimeter wave band can be received (YES in step S503), the communication device 103 executes the operation in step S504, and if not (NO in step S503), the communication device 103 executes the operation in step S506.

In step S504, the communication device 103 receives notification signals of the band types other than the millimeter wave, measures the SSB, and analyzes the SIB and the MIB to acquire communication quality information and communication control information for each band type.

In step S505, the communication device 103 determines the band type that can secure the widest bandwidth, based on the communication quality information and communication control information for the band types other than the millimeter wave band, and starts the RRC connection process.

In step S506, the communication device 103 determines whether notification signals of band types other than the millimeter wave from other base stations can be received. If the notification signals can be received (YES in step S506), the communication device 103 executes the process in step S507, and if not (NO in step S506), the communication device 103 executes the process in step S508.

In step S507, the communication device 103 selects another base station as a candidate for connection destination, and executes the process in step S503 for the selected base station.

In step S508, since there are no other base stations to which connection can be made, the communication device 103 starts the RRC connection process using millimeter waves.

In step S509, since the communication device 103 does not operate as a mobile IAB node, the communication device 103 performs the search for all band types.

In step S510, the communication device 103 selects the base station with the highest received electric field strength from the search results.

In step S511, the communication device 103 analyzes the MIB and SIB for all band types, measures the SSB, acquires communication quality information and communication control information for each band type, and executes the process in step S505.

In step S505, the communication device 103 determines the band type that can secure the widest bandwidth based on the communication quality information and communication control information for all band types, and starts the RRC connection process.

The candidate band types differ depending on whether the operation in step S505 is executed after step S504 or after step S511.

According to the present embodiment, the mobile IAB node does not connect to the IAB donor using millimeter wave, which is prone to disconnection during movement, but instead selects other band types to provide a stable IAB network. Furthermore, even for mobile IAB nodes, if they are stationary, control is performed to enable large-capacity communication by selecting millimeter wave band, thereby allowing the selection of appropriate band types according to status.

### Second Embodiment

In the first embodiment, an example has been described in which the communication device 103 preferentially selects a band type other than the millimeter wave for a cell search, and connects to the donor 101 using the Sub6 band. In a second embodiment, an example will be described in which a mobile IAB node selects a band type according to status information related to mobility and executes a cell search. The descriptions of parts common to those in the first embodiment will be omitted.

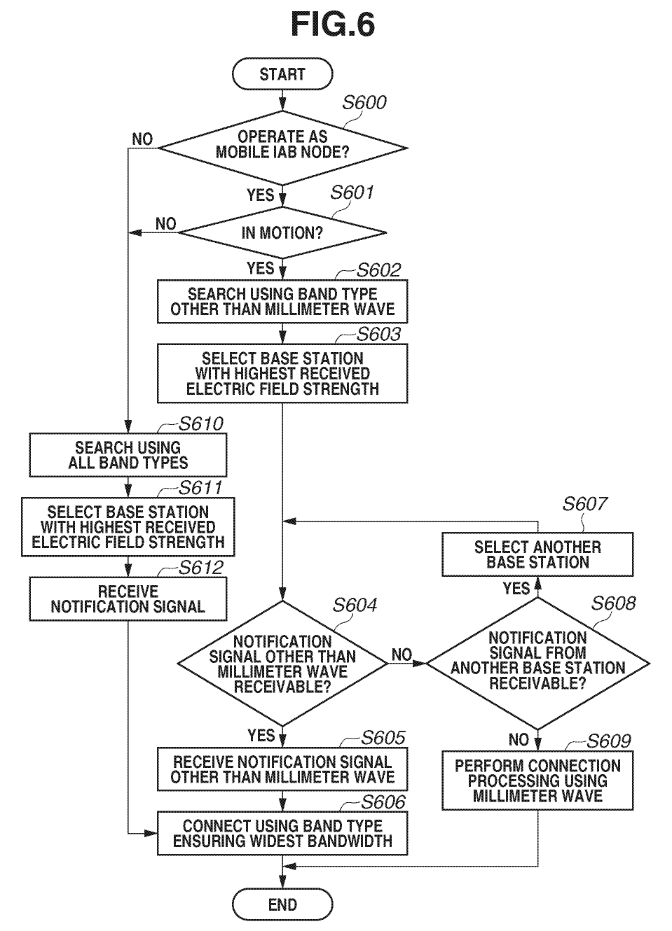

FIG. 6 is a flowchart of an example of a cell search process performed by a mobile IAB node according to the present embodiment.

In step S600, a communication device 103 determines whether the communication device 103 operates as a mobile IAB node.

In step S601, the communication device 103 determines whether the communication device 103 is currently moving. If it is determined that the communication device 103 is moving (YES in step S601), the communication device 103 performs the process in step S602. If it is determined that the communication device 103 is stationary (NO in step S601), the communication device 103 executes the process in step S610. In other words, if the communication device 103 is currently moving, the communication device 103 preferentially selects a band type other than the millimeter wave band to connect to the base station. If the communication device 103 is stationary, the communication device 103 connects using the band type that secures the widest bandwidth among the band types including the millimeter wave band.

Whether the communication device 103 is moving can be determined from the GPS information acquired by a GPS control unit 307. In addition to this method, the determination can be made based on changes in distance measurement information obtained by triangulation using communication with a plurality of base stations and the mobile IAB node, changes in the inertial measurement unit (IMU) or wheel rotation count, or changes in images from an onboard camera.

The processing procedure from step S602 onward is similar to the cell search processing procedure in FIG. 5 corresponding to the first embodiment, and thus description thereof will be omitted.

In the second embodiment, when the communication device 103 attempts to connect to donor 101, the communication device 103 may add identification information indicating that the communication device 103 is a mobile IAB node. For example, the communication device 103 generates a connection request (RRCSetupRequest) to the donor 101. The RRCSetupRequest is a message for requesting establishment of an RRC connection. If the communication device 103 operates as a mobile IAB node after the connection, the communication device 103 adds identification information indicating that the communication device 103 is a mobile IAB node to the RRCSetupRequest. The field for adding identification information may use the spare field of RRCSetupRequest-IEs, the randomValue field of ue-identity, or spare1 to spare6 of establishmentCause. For example, any of spare1 to spare6 may be newly defined as a field such as iab-TypeIndication. If "1" is set in the iab-TypeIndication field, the configuration may be such that the communication device 103 itself being a node capable of moving, specifically, a mobile IAB node, is indicated. If "0" is set, the communication device 103 being an immobile IAB node, specifically, a fixed IAB node may be indicated. In this way, by using a field such as iab-TypeIndication, identification information indicating whether the communication device 103 itself is a mobile IAB node can be provided to other devices.

The addition of such identification information may be implemented by adding a field such as mobileiab-StatusIndication to a RRCSetupComplete message as specified in TS38.331.

### Other Embodiments

In the second embodiment, an example has been described in which a cell search is executed by using a band type selected according to status information related to the mobility of a mobile IAB node.

In addition to the determination based on mobility in step S601 in the second embodiment, the band type for searching millimeter waves may be included even when the mobile IAB node is moving, depending on the distance from the connected base station and the moving speed. That is, the band type may be determined based on additional status information including the distance to the base station and the moving speed, by comparing the distance and the moving speed with predefined thresholds.

Since millimeter waves have a large free space path loss, a highly directional antenna 205 is used to extend the communication distance. Therefore, it is necessary to switch the direction of the antenna 205 while tracking the movement of the communication device 103 that is communicating.

However, if the distance from the base station is short or the moving speed is low, or depending on a combination of these conditions, a backhaul line using millimeter waves can be formed.

In the first embodiment, an example of an operation has been described in which the communication device 103 determines in S500 whether to operate as a mobile IAB node when returning from sleep. However, this is not limited thereto, and the operation mode of the IAB node may be switched between a fixed IAB node and a mobile IAB node based on the operation setting of the IAB node. In this case, the cell search illustrated in FIGS. 5 and 6 may be executed at the time of switching. The operation setting of the IAB node may be changeable based on acquisition of a change input from a user or reception of a change instruction from a base station. For example, the operation setting of the IAB node may be changed by an operation unit of the IAB node or changed in response to a change instruction from the base station.

Although embodiments have been described in detail above, the present disclosure is not limited to specific embodiments, and various modifications and changes are possible within the scope of the appended claims. It is also possible to combine all or some of components of the above-described embodiments.

In addition, the following appendices are disclosed regarding the above embodiments.

### Appendix 1

A communication device including a reception unit configured to receive notification signals of a plurality of band types from a base station, and a connection control unit configured to, in a case where the communication device functions as a mobile IAB node, preferentially attempt connection to one or more base stations that transmit, among the notification signals, a notification signal of a second band type among a first band type related to millimeter waves and the second band type related to a wavelength longer than millimeter waves.

### Appendix 2

The communication device according to appendix 1, wherein the connection control unit preferentially attempts connection to the second band type rather than the first band type for a single base station that is connectable using the plurality of band types including the first band type and the second band type.

### Appendix 3

The communication device according to appendix 1, further including a selection unit configured to select, from among the plurality of band types, a band type to be searched for, and an analysis unit configured to search, via the receiving unit, the notification signal of the band type to be searched for that is selected by the selection unit, and analyze the received notification signals, wherein the connection control unit determines the one or more base stations to which connection is preferentially attempted based on a result of analysis by the analysis unit, and wherein, in a case where the communication device functions as a mobile IAB node, the selection unit selects the second band type as the band type to be searched for.

### Appendix 4

The communication device according to appendix 4, wherein, in a case where there are two or more second band types, the connection control unit preferentially attempts connection to one or more base stations that transmit the notification signal of one second band type among two or more second band types, the one second band type being capable of securing the widest bandwidth.

### Appendix 5

The communication device according to appendix 3, wherein the selection unit varies the band type to be searched for according to a status of the communication device.

### Appendix 6

The communication device according to appendix 5, wherein the status is mobility information indicating whether the communication device is moving or stationary.

### Appendix 7

The communication device according to appendix 6, wherein the selection unit selects the second band type as the band type to be searched for in a case where the status indicates that the communication device is moving.

### Appendix 8

The communication device according to appendix 6, wherein, in a case where the status indicates that the communication device is stationary, the selection unit selects, among the first band type and the second band type, only the first band type or both the first band type and the second band type, as the band type to be searched for.

### Appendix 9

The communication device according to appendix 6, wherein, in a case where the status indicates that the communication device is moving, based on a distance from a base station and a moving speed, the selection unit differently selects only the first band type or selects both the first band type and the second band type, among the first band type and the second band type, as the band type to be searched for.

### Appendix 10

The communication device according to appendix 1, further comprising a switching unit configured to execute switching between operating as a fixed IAB node and operating as a mobile IAB node.

### Appendix 11

The communication device according to appendix 10, further comprising:
a selection unit configured to select a band type to be searched for from among the notification signals of the plurality of band types; and
an analysis unit configured to search, via the receiving unit, the notification signal of the band type to be searched for that is selected by the selection unit, and analyze the received notification signals,
wherein the connection control unit determines the one or more base stations to which the connection control unit preferentially attempts connection based on a result of analysis by the analysis unit, and
wherein, in a case where the communication device functions as a fixed IAB node, the selection unit selects, among the first band type and the second band type, only the first band type or both the first band type and the second band type, as the band type to be searched for.

### Appendix 12

The communication device according to appendix 10, further comprising a changing unit configured to change a function setting based on acquisition of a change input from a user or reception of a change instruction from a base station,

wherein the switching unit executes the switching based on the function setting.

### Appendix 13

The communication device according to appendix 1, wherein the second band type includes at least one of a Sub6 band and a Long Term Evolution (LTE) band.

According to an aspect of the present disclosure, it is possible to provide a mechanism for connecting to an appropriate IAB donor by narrowing a search for the band type to be used by an IAB node for a backhaul line.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

The present invention is not limited to the above embodiments, and various modifications and changes can be made without departing from the spirit and scope of the present invention. Accordingly, the following claims are appended to publicly disclose the scope of the present invention.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication device comprising:
a reception unit configured to receive notification signals of a plurality of band types from a base station; and
a connection control unit configured to, in a case where the communication device functions as a mobile IAB node, attempt connection to one or more base stations that transmit, among the notification signals, a notification signal of a second band type among a first band type related to millimeter waves and the second band type related to a wavelength longer than millimeter waves.

2. The communication device according to claim 1, wherein the connection control unit attempts connection to the second band type rather than the first band type for a single base station that is connectable using the plurality of band types including the first band type and the second band type.

3. The communication device according to claim 1, further comprising:
a selection unit configured to select, from among the plurality of band types, a band type to be searched for; and
an analysis unit configured to search, via the receiving unit, the notification signal of the band type to be searched for that is selected by the selection unit, and analyze the received notification signals,
wherein the connection control unit determines the one or more base stations to which connection is attempted based on a result of analysis by the analysis unit, and
wherein, in a case where the communication device functions as a mobile IAB node, the selection unit selects the second band type as the band type to be searched for.

4. The communication device according to claim 3, wherein, in a case where there are two or more second band types, the connection control unit attempts connection to one or more base stations that transmit the notification signal of one second band type among two or more second band types, the one second band type being capable of securing the widest bandwidth.

5. The communication device according to claim 3, wherein the selection unit varies the band type to be searched for according to a status of the communication device.

6. The communication device according to claim 5, wherein the status is mobility information indicating whether the communication device is moving or stationary.

7. The communication device according to claim 6, wherein the selection unit selects the second band type as the band type to be searched for in a case where the status indicates that the communication device is moving.

8. The communication device according to claim 6, wherein, in a case where the status indicates that the communication device is stationary, the selection unit selects, among the first band type and the second band type, only the first band type or both the first band type and the second band type, as the band type to be searched for.

9. The communication device according to claim 6, wherein, in a case where the status indicates that the communication device is moving, based on a distance from a base station and a moving speed, the selection unit differently selects only the first band type or selects both the first band type and the second band type, among the first band type and the second band type, as the band type to be searched for.

10. The communication device according to claim 1, further comprising a switching unit configured to execute switching between operating as a fixed IAB node and operating as a mobile IAB node.

11. The communication device according to claim 10, further comprising:
a selection unit configured to select a band type to be searched for from among the notification signals of the plurality of band types; and
an analysis unit configured to search, via the receiving unit, the notification signal of the band type to be searched for that is selected by the selection unit, and analyze the received notification signals,
wherein the connection control unit determines the one or more base stations to which the connection control unit attempts connection based on a result of analysis by the analysis unit, and
wherein, in a case where the communication device functions as a fixed IAB node, the selection unit selects, among the first band type and the second band type, only the first band type or both the first band type and the second band type, as the band type to be searched for.

12. The communication device according to claim 10, further comprising a changing unit configured to change a function setting based on acquisition of a change input from a user or reception of a change instruction from a base station,
wherein the switching unit executes the switching based on the function setting.

13. The communication device according to claim 1, wherein the second band type includes at least one of a Sub6 band and a Long Term Evolution (LTE) band.

14. A method for controlling communication, the method comprising:
receiving notification signals of a plurality of band types from a base station; and
attempting, in a case where the communication device functions as a mobile IAB node, connection to one or more base stations that transmit, among the notification signals, a notification signal of a second band type among a first band type related to millimeter waves and the second band type related to a wavelength longer than millimeter waves.

15. A non-transitory computer-readable storage medium storing a program that, when executed by one or more processors of a communication device, causes the communication device to perform:
receiving notification signals of a plurality of band types from a base station; and
attempting, in a case where the communication device functions as a mobile IAB node, connection to one or more base stations that transmit, among the notification signals, a notification signal of a second band type among a first band type related to millimeter waves and the second band type related to a wavelength longer than millimeter waves.
